(19) United States
(12) Patent Application Publication
(10) Pub. No.: US 2022/0383116 A1
(43) Pub. Date: Dec. 1, 2022

(54) METHOD AND SYSTEM FOR TASK MANAGEMENT IN AN INTERNET OF THINGS (IoT) EDGE NETWORK

(71) Applicant: SAMSUNG ELECTRONICS CO., LTD., Suwon-si (KR)

(72) Inventors: Jyotirmoy KARJEE, Bengaluru (IN); Praveen Naik S, Bengaluru (IN); Vanamala Narasimha BHARGAV, Bengaluru (IN); Kartik ANAND, Bengaluru (IN); Srinidhi N, Bengaluru (IN); Ramesh Babu Venkat DABBIRU, Bengaluru (IN); Anshuman NIGAM, Bengaluru (IN)

(73) Assignee: SAMSUNG ELECTRONICS CO., LTD., Suwon-si (KR)

(21) Appl. No.: 17/824,075

(22) Filed: May 25, 2022

(30) Foreign Application Priority Data
May 25, 2021 (IN) 2021 41023357
May 10, 2022 (IN) 202141023357

(51) Int. Cl. G06N 3/08; H04L 67/12; H04L 41/0681; G06F 9/48

(52) U.S. Cl. CPC G06N 3/08; H04L 67/12; H04L 41/0681; G06F 9/4881

(57) ABSTRACT

A method and system of task management in an internet of things (IoT)-edge network may be provided. The method may include assigning at least one deep neural network (DNN) task from an IoT device to a first edge device; determining whether the first edge device satisfies one of a first predetermined criteria and a second predetermined criteria during execution of the at least one DNN task; triggering an alarm to the IoT device based on the determination; identifying a second edge device subsequent to the triggering of the alarm; determining whether to transfer the at least one DNN task to the second edge device or to execute the at least one DNN task on the first edge device, based on determining that the first device satisfies the second predetermined criteria; and transferring the at least one DNN task to the second edge device, based on determining that the first device satisfies the first predetermined criteria.

### CROSS-REFERENCE TO RELATED APPLICATION(S)

This application is based on and claims priority from Indian Patent Provisional Application No. 202141023357, filed May 25, 2021, in the Indian Intellectual Property Office, and claims priority from Indian Patent Complete Application No. 202141023357, filed May 10, 2022, in the Indian Intellectual Property Office, the disclosures of which are incorporated by reference herein in their entireties.

### BACKGROUND

### 1. Field

The present disclosure relates to a method and a system for task management in an internet of things (IoT) edge network.

### 2. Description of the Related Art

For the development of next generation wireless communication, 6G is evolving to provide high speed connectivity and computation services for Internet of Things (IoT). In the 6G era, both computation and communication services expected to be taken care of for futuristic applications (e.g., extended reality (XR), augmented reality (AR), virtual reality (VR), holographic communications, etc.) in IoT devices (e.g., smart watch, Raspberry Pi™, drones, robots, etc.). However, running such applications to provide real time user experience on IoT devices requires extensive computation capabilities. For example, such computational capabilities may include requirement of high speed processor and large storage space for performing complex tasks such as, tasks using deep neural networks (DNN) model. Unfortunately, meeting such computational requirements to run DNN task(s) solely on the IoT devices is a challenge because of limited processing capabilities of IoT devices.

To overcome the limitations of processing capabilities of IoT devices, the concept of split computing is introduced in the 6G domain. Split computing is defined as partitioning one or more DNN task(s) among two or more devices, where the devices can partially or fully upload the task to other nearby devices dynamically depending upon certain criteria or network conditions. Thus, the partitioning of DNN's task(s) is assigned to nearby devices in close proximity such as edge devices in the context of split computing. Although, split computing helps mitigate the limitation of computational storage and communication overhead of IoT devices by introducing edge devices, but it introduces new issues such as increase in battery drainage (or energy consumption/dissipation) in the IoT-edge network. For example, the battery drainage in the IoT-edge network is quicker due to the DNN task(s). Further, it is possible that sometimes data off-loading relating to DNN tasks is not completed in a desired timeline due to network conditions. In such situations, offloading DNN task(s) to nearby devices (such as edge devices) is highly considered rather than relying on cloud. Offloading DNN task(s) to edge devices reduces latency issues thereby reducing the communication overhead. Edge devices are capable of handling the deep learning algorithms because they have sufficient memory space, high processing power and computational speed, etc. compared to IoT devices. However, as DNN task(s) is assigned to edge devices, it is possible that after a certain duration, edge devices run out of battery without finishing the task. For example, an IoT device is continuously charged through external back-up, whereas the edge devices do not have continuous battery power and rely on their battery. Hence, as time progresses, the following issues may appear at edge devices:

(i) Edge devices may run out of battery while the scheduled DNN task(s) allotted to the edge devices may not be completed.

(ii) If prioritized applications are offloaded to an edge device during the execution of DNN task(s) with IoT device, then a determination about whether the edge decide should handle only the prioritized applications, whether the DNN task(s) should be assigned to another nearest edge device, or whether the edge device should perform both the tasks (i.e., DNN task and prioritization), simultaneously needs to be made.

(iii) Because of prioritization, re-assigning DNN task(s) to another edge device without restarting the task in a new edge device to avoid latency factor in load-balancing, i.e., without compromising to re-start the task in new edge to avoid latency.

(iv) Handling multiple DNN task(s) running among different edge devices with prioritized applications scheduled at edge device.

Accordingly, there is a need to provide a mechanism that indicates the edge devices a-priori (beforehand) regarding the battery level status so that using deep learning, the DNN task(s) can be switched to a nearby device without interrupting the DNN task(s). Thus, there is a need to provide techniques which overcome the above discussed problems in the art.

### SUMMARY

This summary is provided to introduce a selection of concepts in a simplified format that are further described in the detailed description of the invention. This summary is not intended to identify key or essential inventive concepts of the invention, nor is it intended for determining the scope of the invention.

According to an embodiment, a method of task management in an internet of things (IoT)-edge network may be provided. The IoT-edge network may include an IoT device and a plurality of edge devices. The method may include assigning at least one deep neural network (DNN) task from an IoT device to a first edge device; determining whether the first edge device satisfies one of a first predetermined criteria and a second predetermined criteria during execution of the at least one DNN task; triggering an alarm to the IoT device based on the determination; identifying a second edge device subsequent to the triggering of the alarm; determining whether to transfer the at least one DNN task to the second edge device or to execute the at least one DNN task on the first edge device, based on determining that the first device satisfies the second predetermined criteria; and transferring the at least one DNN task to the second edge device, based on determining that the first device satisfies the first predetermined criteria.

According to an embodiment, a system of task management in an internet of things (IoT)-edge network may be provided. The IoT-edge network may include an IoT device and a plurality of edge devices. The system may include a memory and a processor coupled to the memory. The processor may be configured to assign at least one deep neural network (DNN) task from an IoT device to a first edge device; determine whether the first edge device satisfies one of a first predetermined criteria and a second predetermined criteria during execution of the at least one DNN task; trigger an alarm to the IoT device based on the determination; identify a second edge device subsequent to the alarm; determine whether to transfer the at least one DNN task to the second edge device or to execute the at least one DNN task on the first edge device, based on determining that the first device satisfies the second predetermined criteria; and transfer the at least one DNN task to the second edge device, based on determining that the first device satisfies the first predetermined criteria.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a diagram depicting a computing mechanism based on IoT-edge devices, in accordance with existing art;

FIG. 2 illustrates a flow diagram depicting a method for split computing mechanism based on IoT-edge devices, in accordance with existing art;

FIG. 3 illustrates flow diagram depicting a method of task management in an internet of things (IoT)-edge network, in accordance with an embodiment of the present disclosure;

FIG. 4 illustrates an exemplary IoT-edge network, in accordance with an embodiment of the present disclosure;

FIG. 5 illustrates a single task load balancing with prioritization (S-TLBP) model, in accordance with an embodiment of the present disclosure;

FIG. 6 illustrates a flow diagram of DNN task execution in a single task load balancing with prioritization (S-TLBP) model, in accordance with an embodiment of the present disclosure;

FIG. 7 illustrates a multiple task load balancing with prioritization (M-TLBP) model, in accordance with an embodiment of the present disclosure;

FIG. 8 illustrates a flow diagram of DNN task execution in a multiple task load balancing with prioritization (M-TLBP) model, in accordance with an embodiment of the present disclosure;

FIG. 9A illustrates a graphical representation of energy consumption for S-TLBP model, in accordance with an embodiment of the present disclosure;

FIG. 9B illustrates a graphical representation of energy dissipation for S-TLBP model, in accordance with an embodiment of the present disclosure;

FIG. 9C illustrates a 3D model for S-TLBP model, in accordance with an embodiment of the present disclosure;

FIG. 10A illustrates a graphical representation of energy consumption for M-TLBP model, in accordance with an embodiment of the present disclosure;

FIG. 10B illustrates a graphical representation of energy dissipation for M-TLBP model, in accordance with an embodiment of the present disclosure; and

FIG. 10C illustrates a 3D model for M-TLBP model, in accordance with an embodiment of the present disclosure; and

FIG. 11 illustrates a block diagram of a system 1100 for task management in an internet of things (IoT)-edge network, in accordance with an embodiment of the present disclosure.

Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present invention. Furthermore, in terms of the construction of the system, one or more components of the system may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

It should be understood at the outset that although illustrative implementations of the embodiments of the present disclosure are illustrated below, the present disclosure may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

It should be noted that the term “DNN task” and “task” has been interchangeably used throughout the specification.

It should be noted that the term “edge” and “edge device” has been interchangeably used throughout the specification.

Computational capabilities of IoT devices (e.g., smart watch, Raspberry Pi™, drones, robots, etc.) may be relatively limited. Due to these limited computational capabilities of IoT devices, running deep neural networks (DNN's) task(s) on IoT devices may be difficult.

Hence, some portion of DNN's inference task is split from IoT devices to other devices in close proximity such as edge devices. The edge devices may be more powerful computing nodes than IoT devices and the edge devices can handle complex DNN tasks. For example, the edge devices may be laptop, smart phone, smart television (TV), personal computer (PC) etc. Thus, in the context of IoT-edge communication, split computing plays a major role in partitioning one or more DNN tasks among IoT-edge in 6G applications.

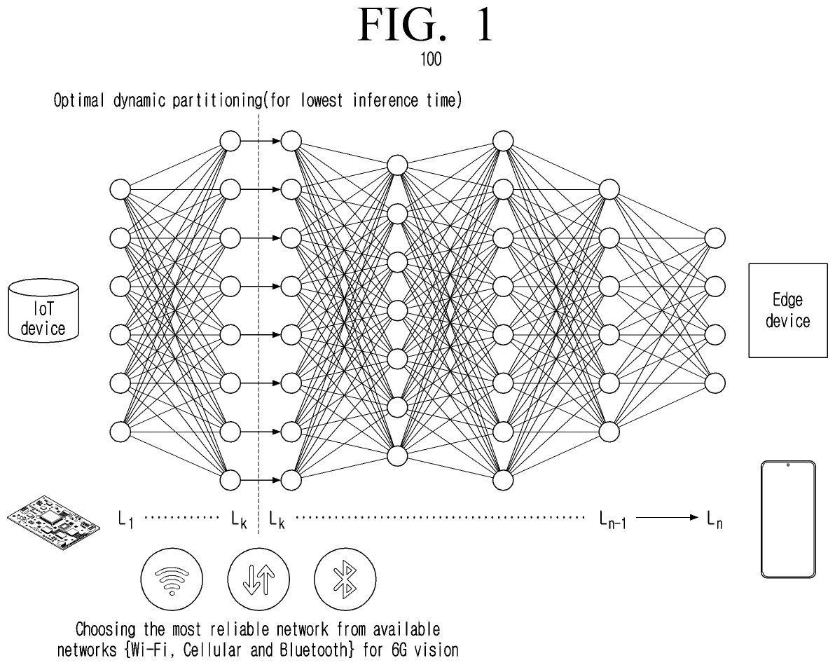

FIG. 1 illustrates a split computing mechanism based on IoT-edge network, in accordance with existing art. Consider an example where an IoT device has to run a neural network with n layers. As shown in FIG. 1, first few layers 1, 2, 3, . . . , k can be executed on the IoT device and k+1, k+2, . . . , n layers can be executed on the edge device to reduce to overall inference time.

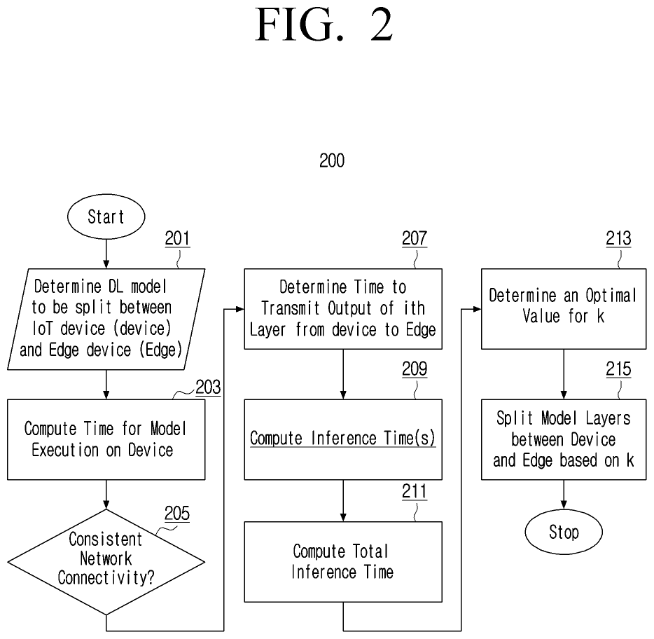

FIG. 2 illustrates a flow diagram depicting a method for split computing mechanism based on an IoT-edge network, in accordance with existing art. At operation 201, the method 200 may include, determining a deep learning (DL) model as a task consisting of N layers {L1, L2, . . . , LN} that may be split among IoT device (sometimes referred to as “device”) and edge device. At operation 203, the method 200 may include, computing a time taken to execute model layers on the IoT device as:

CD={c1D,c2D, . . . ,cND},

Where ciD is the execution time of ith layer on the IoT device.

At operation 205, the method 200 may include, determining if the network has consistent connectivity. In particular, the IoT device periodically calculates the throughput of the network (Wi-Fi/cellular/Bluetooth) by finding the average time taken to share chunks of a large file with the connected edge devices over the network. Dividing the size of each chunk (in bytes) with the time taken to share it gives the network throughput. Then an average of these throughput values may be calculated.

If in operation 205, it is determined that the network has consistent connectivity, then, at operation 207, the method 200 may include, determining time taken to send the output of ith layer from the IoT device to edge device as ti and hence the set: T={t1, t2, . . . , tN}. In particular, for splitting the DNN tasks between the IoT device and the edge device, the method 200 may calculate the time taken to send the output of each layer to the edge device using the periodically calculated network throughput. The method 200 may iterate over each possibility of splitting the DNN task and finds the split-point which gives the minimum theoretical inference time.

At operation 209, the method 200 may include computing a plurality of inference times, the inference times computer including:

(i) Inference Time on IoT Device=ID=c1D+c2D+ . . . +cKD

(ii) Transport Time of output from IoT Device to Edge device=t_{K}

(iii) Inference Time on Edge=I_{E}=cK+1, E+cK+2, E+ . . . +cNE

At operation 211, the method 200 may include, computing a total inference time=I_{D}+t_{K}+I_{E}=c1D+c2D+ . . . +cKD+t_{K}+cK+1,E+cK+2,E+ . . . +cNE

At operation 213, the method may include, finding a value of k, for which the sum, I_{D}+t_{K}+I_{E} is minimized. An optimization problem is given as ArgMin [c1D+c2D+ . . . +cKD+t_{K}+cK+1, E+cK+2, E+ . . . +cNE], kϵ{1, 2, . . . , N}.

At operation 215, the method 200 may include, splitting model layers amongst the IoT device and the edge device, once an optimal k is determined.

However, even after splitting the task, it is possible that the edge device is running-out of battery and the scheduled task may not be completed. To solve this problem, the present disclosure discloses discovering nearby edge devices to the IoT device and assigning the remaining deep neural task to a nearby edge device, if the current edge device is running out of battery using a load balancing mechanism.

Embodiments of the present invention will be described below in detail with reference to the accompanying drawings.

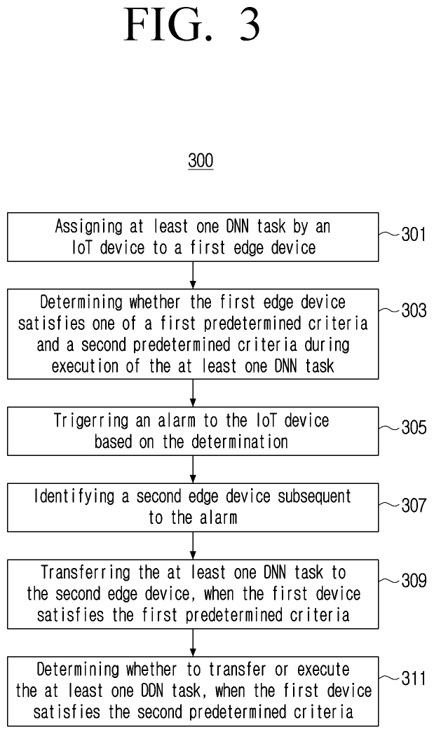

FIG. 3 illustrates a flow diagram depicting a method 300 of task management in an internet of things (IoT)-edge network, in accordance with an embodiment of the present disclosure. In an embodiment, the IoT-edge network may comprise of an IoT device and a plurality of edge devices.

As shown in FIG. 3, at operation 301, the method 300 comprises assigning at least one DNN task by an IoT device to a first edge device. In an embodiment, the IoT device has a first computing capability, and the plurality of edge devices have a second computing capability higher than the first computing capability. For example, the IoT device may be a wearable device (e.g., a smart watch), Raspberry Pi™, etc. and the edge devices may be a smart phone, a personal computer (PC), laptop, smart television (TV), etc.

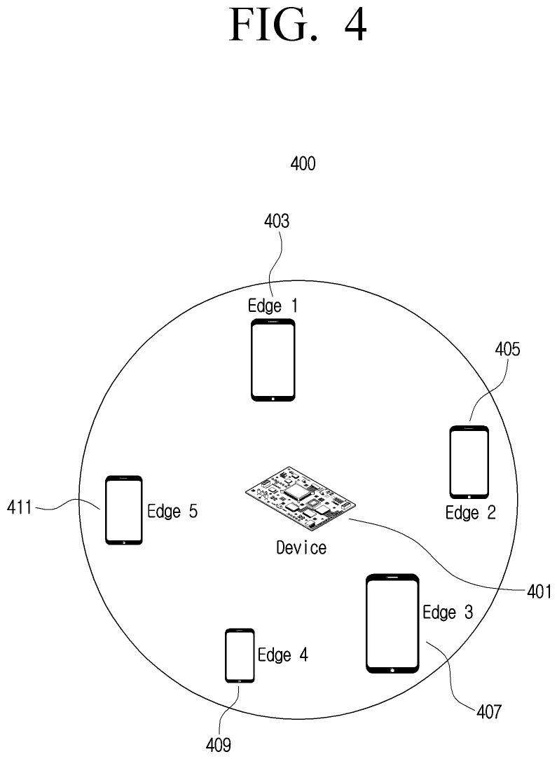

The architecture of the IoT-edge network would now be explained in conjunction with FIG. 4. Specifically, FIG. 4 illustrates an exemplary IoT-edge network, in accordance with an embodiment of the present disclosure. As shown in FIG. 4, the IoT-edge network 400 may consist of an IoT device 401 and five edge devices 403-411. Accordingly, the IoT device 401 may assign the at least one DNN task to the first edge device, i.e., Edge1 403 (Edge1, first edge device, and edge device may be referred to using numeral 403). In another embodiment, if a plurality of tasks have to be assigned, then the plurality of DNN tasks may be split into a group of DNN tasks. These group(s) of DNN tasks are assigned among the plurality of edge devices 403-411. It should be noted that the DNN tasks may be split into plurality of tasks in accordance with FIG. 2. In an exemplary embodiment, two DNN tasks, i.e., task-1 and task-2 may need to be computed. Task-1 and task-2 may be assigned to Edge-4 409 and Edge-1 403, respectively.

In an embodiment, prior to assigning the DNN task to the edge device, a nearest edge device may be identified as the first edge device using a path loss method. In other words, an edge device which is nearest to the IoT device in the IoT-edge network is identified and the DNN task may be assigned to the identified edge device. In an embodiment, the nearest device may be identified using a path loss method. Referring to FIG. 4, the edge devices 403-411, herein referred to as E, are within the communication range of the IoT device 401, herein referred to as D. If the edge devices 403-411 are situated within the communication range of IoT device 401, then euclidian distance Dis (E;D) is calculated and the path-loss model is computed among them, under network service discovery (NSD) mechanism. Initially, the IoT device 401 may choose the nearest neighbor edge device based on path-loss model to determine k, the optimal split computing point among IoT device and the edge device for NSD to compute the total inference time which may be expressed by:

$${I}_{Total} = arg {min}_{K ∈ \{ 1 , 2 , … , N \}} \{ {I}_{D} + {t}_{K} + {I}_{E} \} \qquad ( 1 )$$

where ID is the inference time on the IoT device to compute the DNN task. I_{D} is calculated as below:

I_{D}=cD1+cD2+ . . . +cDK, where cDi may be the execution time of ith layer on the IoT device.

Similarly, I_{E} is the inference time on the edge device to compute the DNN task. I_{E} may be calculated as below:

I_{E}=cEK+1+ . . . +cEN, where cEi may be the execution time of ith layer on the edge device. Finally, t_{K} may be expressed as the transport time from the IoT device to the edge device.

Hence, the IoT device 401 discovers all the edge devices in the network using NSD and maintains a list of all the edge devices in a sorted order (e.g., ascending order, descending order, custom order, etc.) according to their distance from the IoT device 401. The IoT device 401 may select the edge device which is nearest to it, and establish a reliable transport channel with the edge device 403 based on the throughput of the available networks (such as Wi-Fi, Cellular, Bluetooth and similar networks). In an exemplary embodiment, in reference to FIG. 4, the first edge device 403 is identified as the nearest edge device. Accordingly, the task is split between the IoT device 403 and the edge device 403 using the splitting mechanism, as described in reference to FIG. 2 and an end-to-end pipeline (such as neural network (NN) streamer) is established for the task execution. Similarly, in another embodiment, if multiple tasks are to be assigned, then multiple edge devices are identified using the path loss method. For example, the edge devices in a decreasing order according to their distance from the IoT device 401 can be identified to assign the tasks. In an exemplary embodiment, in reference to FIG. 4, the edge devices, Edge1 403 and Edge4 409 are identified as the nearest edge devices. In an embodiment, the edge device, Edge1 403 is the nearest device and the edge device, Edge4 409 is the second nearest device. Accordingly, the multiple tasks, i.e., task 1 and task 2 are assigned to edge devices, Edge1 403 and Edge4 409 respectively.

Continuing with FIG. 3, at operation 303, the method 300 comprises determining whether the first edge device satisfies one of a first predetermined criteria and a second predetermined criteria during execution of the at least one DNN task. In an embodiment, the first predetermined criteria is related to a battery level of the first edge device, i.e., Edge 1 403 of FIG. 4. In an embodiment, the first predetermined criteria may be determined by monitoring the battery level of the first edge device 403 during execution of the at least one DNN task and determining if the battery level of the first edge device 403 is below a predefined threshold. In an embodiment, the IoT device 401 may monitor the battery level of the edge device 403 by receiving battery level from the edge device 403, periodically. For example, the edge device 403 may share its battery level every one minute, 5 minutes etc. In particular, the edge device 403 may monitor its battery level while performing the assigned task. Then, the IoT device 400 may determine if the battery level of the edge is lower than a predefined threshold, and the IoT device may be notified (e.g., an alarm may be triggered). In an embodiment, the predefined threshold may be configurable, for example, it may be configured as 10% of maximum battery level.

In an embodiment, the second predetermined criteria is related to a priority task and may be determined by determining whether the priority task is assigned to the first edge device, i.e., Edge1 403.

In an embodiment, the IoT device 400 may receive an indication from the edge device 403 if the task assigned to the edge device 403 is a priority task. In an embodiment, the examples of priority tasks may be—attending audio/video calls, capturing photos with camera etc. Some low priority tasks may be be uploading data to a server or downloading data from the internet in the background, updating a database in the background etc. It should be noted that the priority order may be predefined by a user or the IoT device.

Thereafter, at operation 305, the method 300 may comprise triggering an alarm on the IoT device based on the determination. In an embodiment, the alarm may be triggered in a form of a text. In particular, when the battery level of the edge device 403 is below the predefined threshold or a priority task has been assigned to the edge device 403, then an alarm may be triggered.

Then, at operation 307, the method 300 may comprise identifying a second edge device subsequent to the alarm. In an embodiment, the second edge device may be identified using path loss method, as discussed above.

Continuing to FIG. 3, if it is determined that the edge device 403 satisfies the second predetermined criteria, then, at operation 309, the method 300 may comprise transferring the at least one DNN task to the second edge device, when the first device satisfies the first predetermined criteria. In an embodiment, since the edge device 403 has already executed some part of the DNN task, hence, the remaining part of the at least one DNN task may be transferred. In other words, if the battery level of the first edge device is below than a predefined threshold, then the DNN task is transferred to the second edge device, without restarting the execution of the task. The IoT device receives status of the DNN task from the first edge device and assigns the remaining task to the second edge device. For example, with reference to FIG. 4, if battery level of Edge1 403 is below a predefined threshold while executing the DNN task, then the IoT device 401 may receive status of the task from Edge1 403 and may assign the remaining task to Edge4 405, which is the second nearest device to the IoT device 401.

Alternatively, if it is determined that the edge device 403 satisfies the second predetermined criteria, then at operation 311, the method 300 may comprise determining whether to transfer or execute the at least one DNN task. Upon determining that the first device satisfies the second predetermined criteria, the at least one DNN task may be transferred to the second edge device for execution while the priority task is executed at the first edge device. In an exemplary embodiment, referring to FIG. 4, if a priority task is assigned to first edge device, Edge 1 403 while executing the DNN task, then the IoT device 400 may transfer the DNN task to the second edge device, Edge 4 409, and the first edge device, Edge 1 403 may execute the priority task. The IoT device connects to second edge device, which is second nearest to it. The IoT device receives the status of the DNN task from the first edge device and assigns the remaining task to the second edge device.

In another embodiment, upon determining that the first device satisfies the second predetermined criteria, the priority task may be transferred to the second edge device while the at least one DNN task is executed at the first edge device while. In an exemplary embodiment, referring to FIG. 4, if a priority task is assigned to first edge device, Edge 1 403 while executing the DNN task, then the IoT device 400 may transfer the priority task to the second edge device, Edge 4 409 and the first edge device, Edge 1 403 may execute the DNN task.

In an embodiment, the operations 309-311 may be performed in any order and may be performed based on total energy consumptions, as discussed below:

Based on the task completion time (i.e., finish time) which is mapped to total inference time, the total energy consumptions is computed (in Joules) in the network, which is given by:

$${Eng}_{Total} = \{ {Engt}_{K} + {EngI}_{E} \} s . t = \{ \begin{matrix}\begin{matrix}If priortized - apps , then schedule \\ If battery - level \leq thd , then schedule\end{matrix} \\ If {I}_{Total} ⟶ f ( {Eng}_{Total} ) , then finish - time\end{matrix} \qquad ( 2 )$$

where Engt_{K} and EngI_{E} are jointly defined as an energy function f(Eng_{Total}) for energy consumed for transport time and the energy consumed for inference time taken at edge device, respectively.

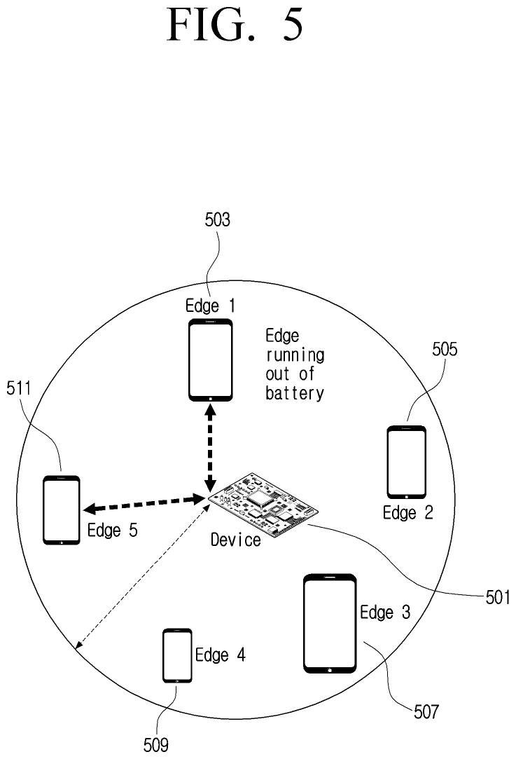

FIGS. 5-8 illustrates specific implementation of the method described in reference to FIG. 3, in accordance to an embodiment of the present disclosure.

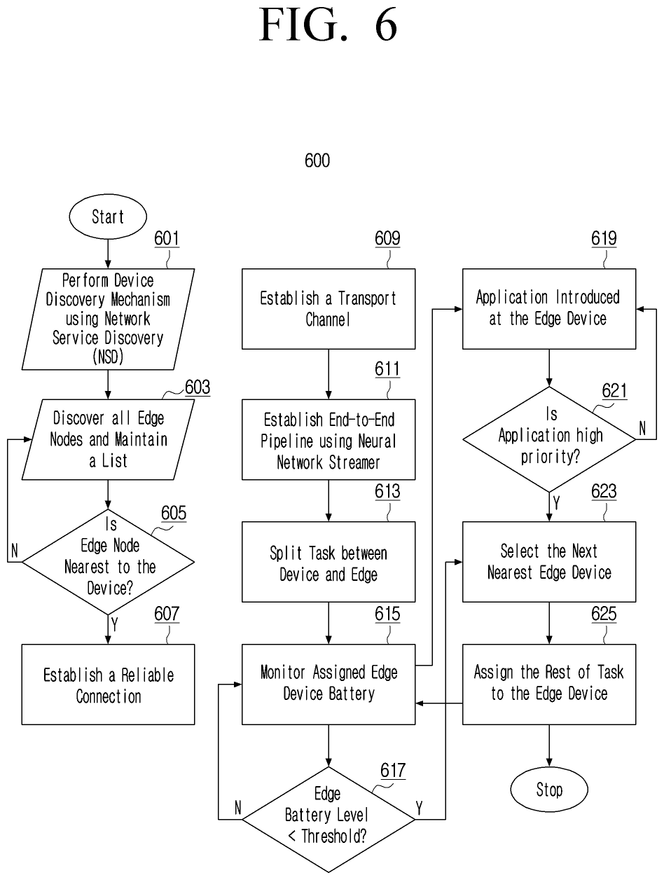

In an embodiment, when a single DNN task is to be executed at an edge device, then a single task load balancing with prioritization (S-TLBP) model may be implemented. FIG. 5 illustrates a single task load balancing with prioritization (S-TLBP) model, in accordance with an embodiment of the present disclosure. As shown in FIG. 5, the S-TLBP model 500 may comprise of an IoT device 501 and five edge device Edge1-Edge5 503-511. The IoT device 501 may assign a DNN task to an edge device, Edge1 503. However, the edge device, Edge1 503 may run out of battery while executing the task. Then, the task may be reassigned to edge device, Edge 5 511, in accordance with technique described in FIG. 6.

FIG. 6 illustrates a flow diagram of DNN task execution in a single task load balancing with prioritization (S-TLBP) model, in accordance with an embodiment of the present disclosure. At operation 601, the method may include, performing device discovery mechanism by device using Network Service Discovery (NSD), as described in reference to FIG. 3. At operation 603, the method may include, discovering by device, all the edge nodes within its communication range and maintaining a list with its distance and path loss component. At operation 605, the method may include, determining if the edge node is nearest to the device. If no, then the method goes back to operation 603. If yes, then the method moves to operation 607.

At operation 607, the method may include, establishing a reliable connection based on throughput value of networks (Wi-Fi/cellular/Bluetooth). For example, edge device 503 may be identified as the nearest edge device and a reliable connection may be established between the IoT device 501 and the edge device 503. At operation 609, the method may include, establishing a transport channel through (such as using Google Remote Procedure Call (gRPC) based Real-time Transport (RTP) packets over User Datagram Protocol (UDP)) between the IoT device 501 and the edge device 503.

At operation 611, the method may include, establishing an end-to-end pipeline (such as using neural network (NN) streamer).

At operation 613, the method may include, splitting the DNN task to be computed among the IoT device 501 and the edge device 503 based on splitting mechanism, as discussed in FIG. 2.

At operation 615, the assigned edge device 503 keeps monitoring the energy/battery level.

At operation 617, the method may include, determining if the battery level<=predefined threshold value. If no, then the method goes back to operation 615. If yes, then the method moves to operation 623. At operation 619, the method may include, introducing a priority application to assigned edge device 503 which is performing DNN task.

At operation 621, the method may include, determining if the introduced application is a priority application or a high priority application. If no, then the method goes back to operation 619. If yes, then the method moves to operation 623. At operation 623, the method may include, selecting by the IoT device 501, the next nearest edge device 511 based on path loss model and follows from operation 607 to operation 613.

At operation 625, the method may include, assigning by the IoT device 501, the rest of the DNN task to the newly assigned edge device 511 to perform split computing. Till the task is completed, method goes from operation 625 to operation 615 and the cycle continues. Once the task is completed, the method is terminated.

Therefore, a DNN task is executed in an IoT-Edge network according to an embodiment.

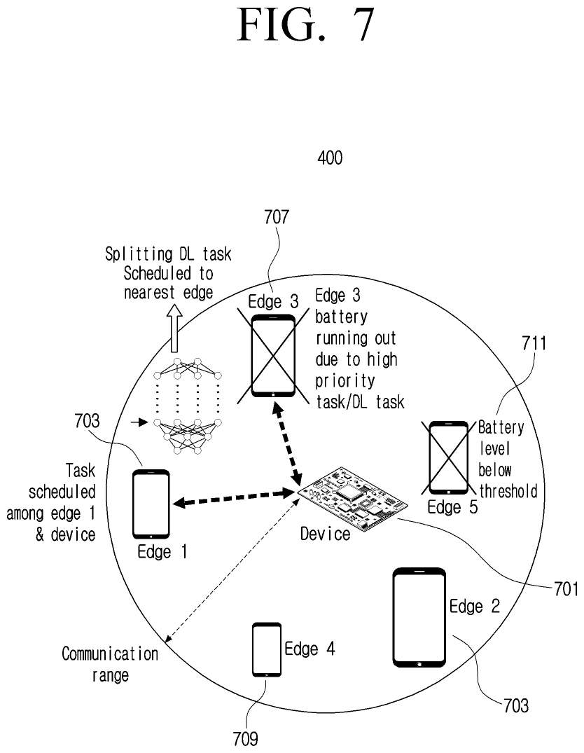

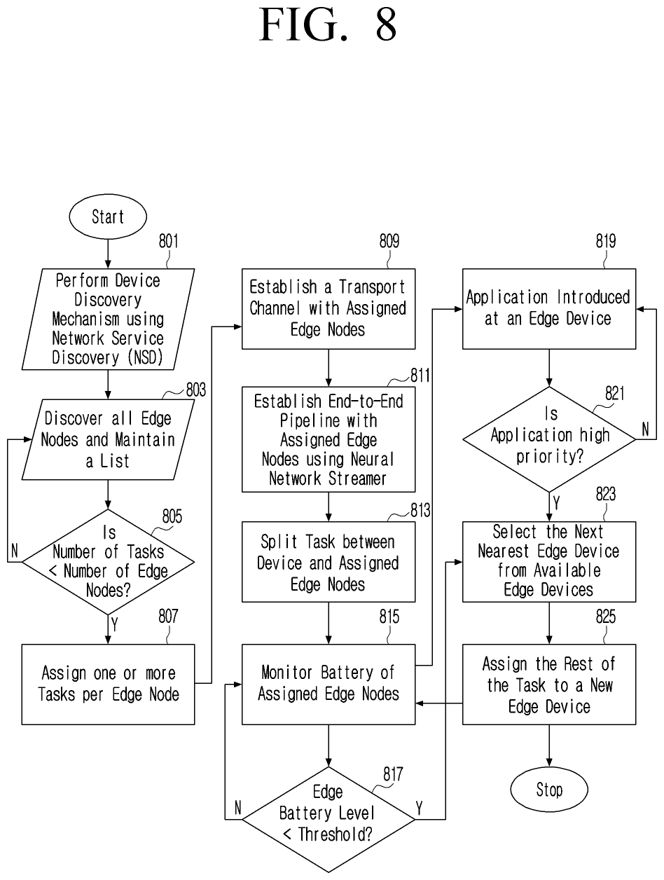

In an embodiment, when a plurality of DNN tasks is to be executed at an edge device, then a multiple task load balancing with prioritization (M-TLBP) model may be implemented. FIG. 7 illustrates a multiple task load balancing with prioritization (M-TLBP) model, in accordance with an embodiment of the present disclosure. As shown in FIG. 7, the M-TLBP model 700 may comprise of an IoT device 701 (also referred to “device” 701) and five edge devices Edge1-Edge5 703-711. As shown in FIG. 7, the edge device, Edge-5 711 is unavailable for computing as it is outside the communication range of the IoT device 701. In M-TLBP model, let us consider that two DNN tasks, i.e., Task-1 and Task-2 are to be computed. The Task-1 and Task-2 are scheduled on Edge-4 709 and Edge-1 703, respectively based on path loss method, as discussed in reference to FIG. 3. After some iterations, a high priority application is introduced to Edge-1 703 which starts consuming its battery, so Task-2 is scheduled to next nearest available edge, i.e. Edge-3 707. Task-1 keeps continuing in Edge-4 709 without any disturbance. After a plurality of iterations, another priority application is introduced on Edge-3 707 which starts running out of battery. Hence, Task-2 is scheduled to Edge-2 705. After some iterations, Task-1 and Task-2 are completed on Edge-4 707 and Edge-2 705, respectively. The tasks may be assigned and completed, in accordance with technique described in FIG. 8.

FIG. 8 illustrates a flow diagram of DNN task execution in a multiple task load balancing with prioritization (M-TLBP) model, in accordance with an embodiment of the present disclosure. At operation 801, the method may include, performing device discovery mechanism by device using Network Service Discovery (NSD), as discussed in reference to FIG. 3. At operation 803, the method may include, discovering by device, all the edge nodes within its communication range and maintaining a list along with its distance and path loss component. At operation 805, the method may include, determining if number of tasks is less than the number of edge devices. If no, then the method moves to operation 803. If yes, then the method moves to operation 807.

At operation 807, the method may include, assigning task per edge device based on nearest distance from the IoT device 701 to edge devices. For example, Task-1 and Task-2 are scheduled on Edge-4 709 and Edge-1 703, respectively. Rest of the edge devices are not assigned any task.

At operation 809, the method may include, establishing a reliable connection based on throughput of available networks (Wi-Fi, Cellular, Bluetooth) with the IoT device 701 and the edge devices 703, 709.

At operation 811, the method may include, establishing a transport channel (through gRPC) among device and the assigned edge nodes along with establishing end-to-end pipeline (such as using NN-Streamer).

At operation 813, the method may include, splitting the DNN tasks to be computed among the IoT device 701 and all the assigned edge devices 703, 709 based on splitting mechanism.

At operation 815, the method may include monitoring by each edge device, the energy/battery.

At operation 817, the method may include, determining if the battery level of any of the edge device is less than a predefined threshold value. If the battery level is not less than the predefined threshold value, then the method goes back to operation 815 and continues monitoring battery levels. If the battery level is less than the predefined threshold value, then the method moves to operation 823. At operation 819, the method may include, introducing a priority application to one of the assigned edge devices 703, 709. At operation 823, the method may include, determining if the application is a high priority application. If the application is not a high priority application, then the method goes back to operation 819. If the application is a high priority application, then the method moves to operation 823. As an example, a priority task is assigned to the edge device 703.

At operation 823, the method may include, selecting by the IoT device 701, the next nearest edge device 707, which is not yet assigned any task from the discovery list (operation 803).

At operation 825, the method may include, assigning by the device 701, the remaining DNN task from the edge device 703 is assigned to newly selected edge device 707 and the other edge device 709 keeps continuing computing the assigned tasks. Flow goes from operation 825 to operation 815, until all the assigned tasks complete execution. Once all the tasks are completed, the method is terminated.

Therefore, a plurality of DNN tasks may be executed in an IoT-Edge network according to an embodiment.

In an embodiment, energy dissipation for Load-balancing models, i.e., S-TLBP and M-TLBP models is determined. In this embodiment, energy (or battery) consumption rate Eng_{R} per unit time against the energy consumption (Engᵢ) to process one (or more DNN) task for edge Ej is considered, where j=1, 2, . . . N; for Eng_{Total}={Engt_{K}+EngI_{E}} during the completion of DNN tasks. Further, during scheduling of one (or more) DNN task among IoT devices and edge devices, the energy consumption increases by Engij where i=1 considered as only one IoT device, D in this use-case scenario. Finally, the completion time of one (or more) scheduling DNN task is summarized followed by the overall total energy (or battery) dissipation as:

$${Eng}_{diss} = {Eng}_{{R}_{11}} ( {Eng}_{11} ) ( {W}_{11} + {P}_{11} ) + {Eng}_{{R}_{12}} ( {Eng}_{12} ) ( {W}_{12} + {P}_{12} ) + … + {Eng}_{{R}_{1 N}} ( {Eng}_{1 N} ) ( {W}_{1 N} + {P}_{1 N} ) \qquad ( 3 )$$

$${Eng}_{diss} = {Eng}_{Total} {\sum }_{i = 1 , j = 1}^{j = N} {Eng}_{{R}_{ij}} {\sum }_{i = 1 , j = 1}^{j = N} ( {W}_{ij} + {P}_{ij} ) \qquad ( 4 )$$

where Eng_{Total} is the total energy consumptions (in Joules) of the IoT-edge network. Further, Eng_{R} is the energy rate, W is the waiting-time and P is the processing time among IoT device and edge device. Using the disclosed S-TLBP and M-TLBP, the waiting time is significantly reduced, thereby reducing the latency factor in load-balancing without compromising to restart DNN inference task in new edge device.

In an embodiment, an iteration may refer to each assignment/reassignment of DNN tasks from the IoT device to the edge device.

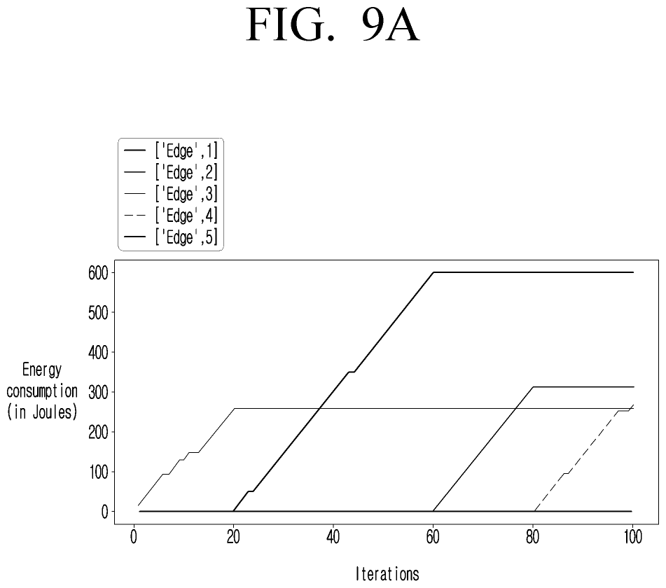

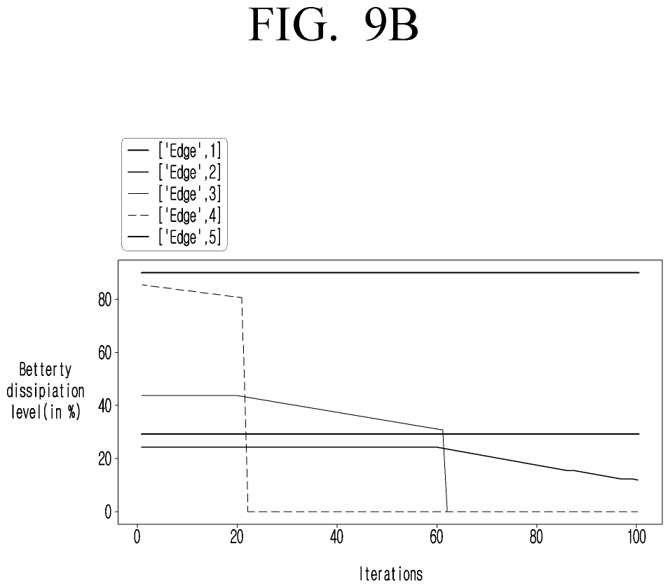

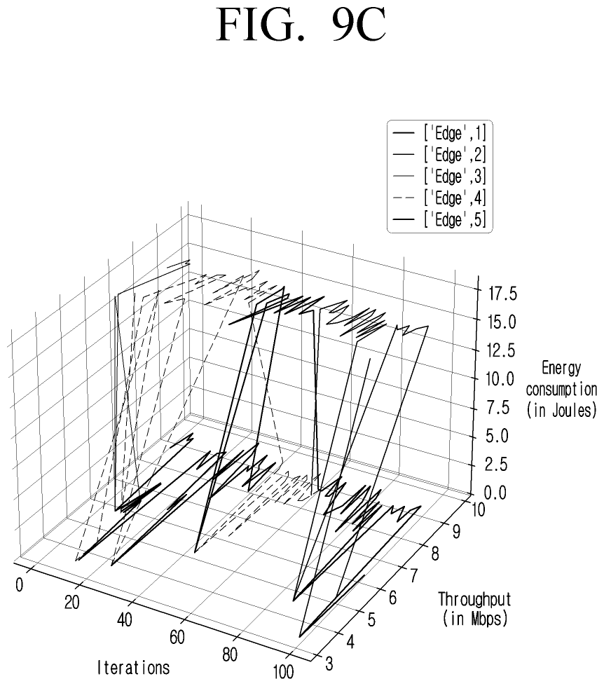

FIG. 9A illustrates a graphical representation of energy consumption for S-TLBP model, in accordance with an embodiment of the present disclosure. In FIG. 9A, edge devices are considered as Edge 1, Edge 2, Edge 3, Edge 4 and Edge 5 for which their battery percentage levels are 34%, 38%, 31%, 47% and 8%, respectively. All five edge devices are within communication range of the IoT device and are available for computing except Edge 5, as its battery level is below the threshold value. In S-TLBP, a single DNN task is considered to be scheduled among edge devices. At iteration 1, the task is scheduled on Edge 3 and starts computing. After 20 iterations, a high priority application is introduced on Edge 3 which starts consuming its battery. Hence, the DNN task is scheduled to next nearest edge that is Edge-1 based on path-loss. After 60 iterations, Edge 1 gets a priority application and the DNN task is scheduled to Edge 2. After another 20 iterations, Edge 2 gets a priority application and the DNN task is shifted to Edge 4 where the computing is completed. Energy consumption of each edge devices is observed in FIG. 9A, as they perform DNN task computing over iterations based on S-TLBP model.

FIG. 9B illustrates a graphical representation of energy dissipation for S-TLBP model, in accordance with an embodiment of the present disclosure. In FIG. 9B, five edge devices are considered with their battery levels as 29%, 24%, 43%, 85% and 89% to interpret the energy dissipation of S-TLBP. Only one DNN task is scheduled to Edge-4 based on path loss model, battery level above threshold value where its battery starts draining while performing the DNN task. After 20 iterations, a priority application is introduced on Edge-4, which starts consuming battery. Hence, the DNN task is scheduled to next nearest edge device, i.e., Edge 3. Again after 60 iterations, Edge-3 receive a priority application for which the battery starts running out and the task is scheduled to next nearest edge, i.e., Edge-2. Finally, the DNN task is completed on Edge-2. Battery dissipation of all the edge devices, as they performed the DNN task over 100 iterations is shown in FIG. 9B.

FIG. 9C illustrates a 3D model for S-TLBP model, in accordance with an embodiment of the present disclosure. In FIG. 9C, edge devices are considered as Edge 1, Edge 2, Edge 3, Edge 4 and Edge 5 for which their battery percentage levels are 31%, 24%, 12%, 30% and 88%, respectively. All five edge devices are within communication range of IoT device and are available for computing. FIG. 9C indicates variation of energy consumption with respect to available throughput across all the edge devices for 100 iterations. For S-TLBP, only one DNN task is to be computed among available edge devices based on energy dissipation. Based on path loss model, DNN task is scheduled to Edge 3. Edge 3 starts computing the task until its battery level drops below threshold. It can be seen from FIG. 9C that with increase in throughput, computation happens on edge device and hence increases its energy consumption. At iteration 9 the battery level of Edge 3 drops below threshold, the DNN task is shifted to next nearest edge device that is Edge 4. Edge 4 continues computing the task till iteration 40 where a priority application is introduced to it. From FIG. 9C, it is evident that whenever throughput is low, the DNN task computation happens on IoT device and hence energy consumption at that particular iteration is zero. At iteration 40 the task is shifted to next nearest available edge device for computing that is Edge 5. Here also, similar pattern in energy consumption can be seen based on available throughput. Finally, task is shifted from Edge 5 to Edge 2 due to introduction of priority task on Edge 5. The DNN task computation is completed on Edge 2. So, it is conclusive from FIG. 9C that energy consumption varies with accordance of the available throughput which decides computation to be completed on Edge device or IoT device based on split computation.

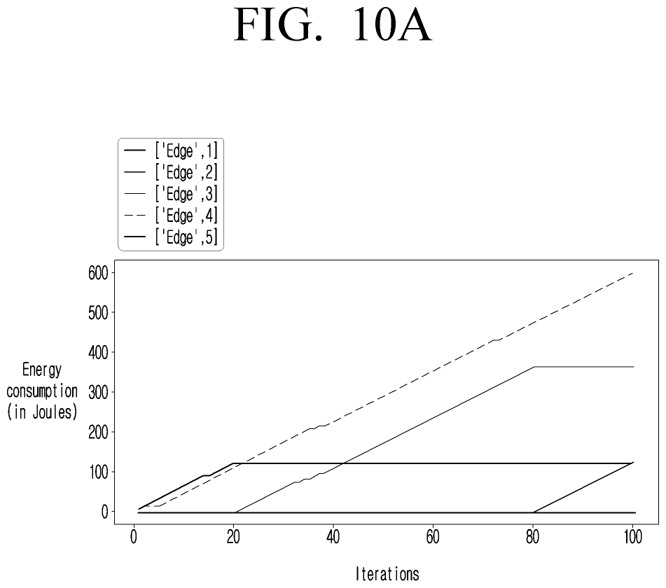

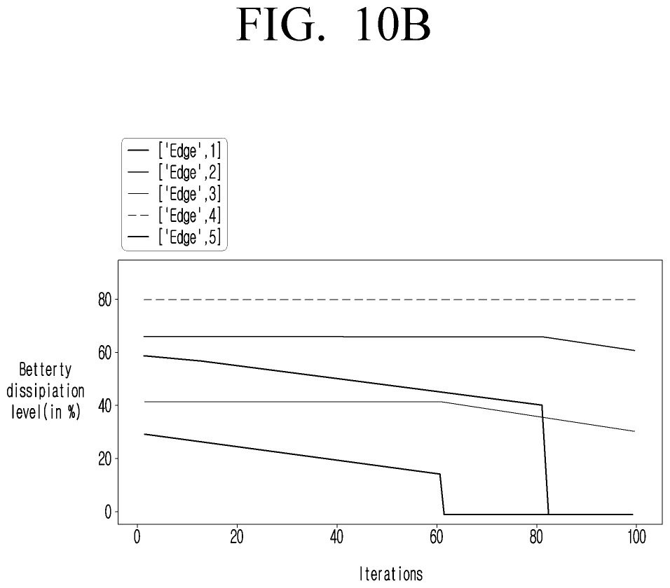

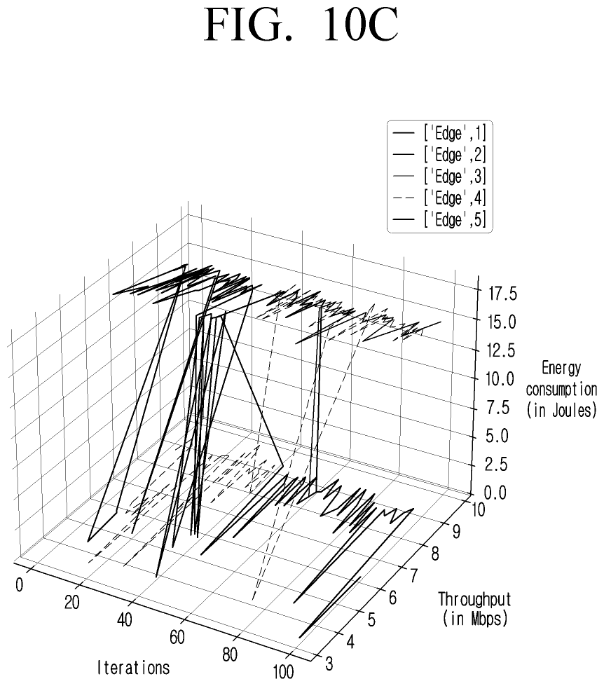

FIG. 10A illustrates graphical representation of energy consumption for M-TLBP model, in accordance with an embodiment of the present disclosure. In FIG. 10A, edge devices are considered as Edge 1, Edge 2, Edge 3, Edge 4 and Edge 5 for which their battery percentage levels are 45%, 88%, 99%, 73% and 93%, respectively. The Edge-5 is unavailable for computing as outside the communication range of IoT device. In M-TLBP, two DNN tasks are considered to be computed. The Task-1 and Task-2 are scheduled on Edge-4 and Edge-1, respectively based on path loss model. After 20 iterations, a priority application is introduced to Edge-1 which starts consuming its battery; so Task-2 is scheduled to next nearest available edge device i.e. Edge-3. Task-1 keeps continuing in Edge-4 without any disturbance. After 80 iterations, another priority application is introduced on Edge-3 which starts running out of battery. Hence, Task-2 is scheduled to Edge-2. After 100 iterations, Task-1 and Task-2 are completed on Edge-4 and Edge-2, respectively. Thus, in FIG. 10A, energy consumption of each edge device is observed as they perform multiple DNN task computation over 100 iterations.

FIG. 10B illustrates a graphical representation of energy dissipation for M-TLBP model, in accordance with an embodiment of the present disclosure. In FIG. 10B, five edge devices are considered with their battery levels as 37%, 81%, 51%, 98%, 73% to show the energy dissipation of M-TLBP. Two DNN tasks are considered. The Task-1 is scheduled to Edge-5 and the Task-2 is scheduled to Edge-1 based on path-loss model. Battery level dissipation are performed for all edge devices to compute DNN tasks over 100 iterations. At iteration 60, a priority application is introduced on Edge-1 and its battery starts running out. Hence Task-2 is shifted to next nearest edge device; i.e. Edge-3. After 20 more iterations, Edge-5 gets busy due to priority applications and the Task-1 is shifted to Edge-2. After 100 iterations, Task-1 and Task-2 are completed on Edge-2 and Edge-3, respectively.

FIG. 10C illustrates a 3D model for M-TLBP model, in accordance with an embodiment of the present disclosure. In FIG. 10C, edge devices are considered as Edge 1, Edge 2, Edge 3, Edge 4 and Edge 5 for which their battery percentage levels are 91%, 96%, 67%, 46% and 66%, respectively. All five edge devices are within communication range of IoT device and are available for computing. FIG. 10C indicates variation of energy consumption with respect to available throughput across all the edge devices for 100 iterations. For M-TLBP, two DNN tasks are considered for simulation. Task 1 and Task 2 are scheduled on Edge 5 and Edge 1 respectively based on path loss model and their battery levels above threshold. From FIG. 10C, it can be seen that with the increase in throughput of edge devices, their energy consumption increases because computation happens on edge device rather than on the IoT device. Also at some iterations, when throughput is less, computation happens on the IoT device rather than the edge device. Hence energy consumption at those iterations is zero. At iteration 40, a priority application is introduced on Edge 5 so task 1 is shifted to Edge 4. FIG. 10C only indicates energy consumption of edge device when they are performing a DNN task. So, energy consumption of Edge 5 is represented as zero in the FIG. 10C. While performing given DNN tasks, based on throughput it is decided if task is shifted to edge device or IoT device. Thus, their energy consumption is affected by available throughput. At iteration 60, a priority application is given to Edge 1 so task 2 is shifted to Edge 2 as battery of Edge 1 starts running out while performing the priority application. Task 1 and task 2 are completed on Edge 4 and Edge 2 respectively. It can be concluded from FIG. 10C that while performing multiple tasks over given edge devices based on load balancing, with the increase in throughput, computation happens on edge devices and hence increases the energy consumption of edge devices performing the tasks.

In an embodiment, a reinforcement learning model to know the battery level a-priori of edge devices is disclosed. The following describes reinforcement Learning model for efficient energy usage:

States: s={e, b}

Where eϵ{1, 2, . . . , E} represents the current energy level of the edge device (E being the maximum energy level} and b is the bandwidth available with the chosen network (Wi-Fi/cellular/Bluetooth) in 5G/6G.

Action Set={on-device inference,
edge-device inference over Wi-Fi,
edge-device inference over cellular,
edge-device inference over Bluetooth}

Goal: To find an optimal policy (i.e., optimal action at every state) for the IoT device to lower battery consumption and also perform neural network inference in allotted time T to know the batter level a-priori.

Outcomes:

1, if task is completed in T time with no change in battery level—provide Reward+1

If task is completed in T time with drop in battery level—provide Reward

−1, if task does not get completed—provide Penalty

Check Penalty<predefined threshold value, If penalty is less than predefined threshold value—switch to nearest edge device

Q-learning to find optimal policy:
Q-learning helps in figuring out how useful an action is in gaining some future reward.
Q*(s, a) represents expected value (cumulative reward) of doing action a in state s and then following the optimal policy.
The agent (IoT device) maintains a table of Q[S, A] where S is the set of states and A is the set of actions. Q[s, a] represents the current estimate of Q*(s, a).
Over a number of iterations, the device performs different actions at different states and updates the Q[S, A] table. Most of the times, it performs the action a with most expected reward. But randomly sometimes, it takes a random action to explore other options.
Finally, it is able to generate the optimal policy based on the obtained values of Q*(s, a) to decide the battery level a-priori of edge device.
If the outcome is as Reward, the device node and the edge device continue to perform the split computation task.
If the outcome is as Penalty, it checks the energy profiling value if it the less than a predefined threshold value. If the energy profile value of edge node is less than threshold, the task is switched to nearest another edge node.

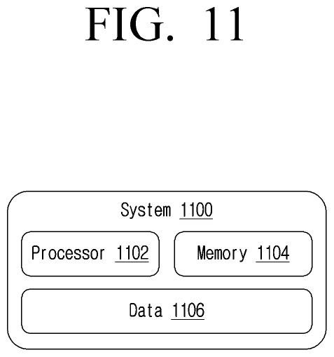

FIG. 11 illustrates a block diagram of a system 1100 for task management in an internet of things (IoT)-edge network, in accordance with an embodiment of the present disclosure. The IoT-edge network may comprise of an IoT device and a plurality of edge devices. The system 1100 may include, but is not limited to, a processor 1102, memory 1104, and data 1106. The memory 1104 may be coupled to the processor 1102. In an embodiment, the processor 1102 may be configured to assign at least one DNN task by an IoT device to a first edge device, determine whether the first edge device satisfies one of a first predetermined criteria and a second predetermined criteria during execution of the at least one DNN task, trigger an alarm to the IoT device based on the determination, identify a second edge device subsequent to the alarm, transfer the at least one DNN task to the second edge device, when the first device satisfies the first predetermined criteria; and determine whether to transfer or execute the at least one DNN task, when the first device satisfies the second predetermined criteria. In an embodiment, the system 1100 may be configured to perform the method as discussed in respect to FIGS. 3-10. Further, the system 1100 may be a part of the IoT device or edge device. In another embodiment, the system 1100 may be connected to the IoT device or edge device.

The processor 1102 can be a single processing unit or several units, all of which could include multiple computing units. The processor 1102 may be implemented as one or more microprocessors, microcomputers, microcontrollers, digital signal processors, central processing units, state machines, logic circuitries, and/or any devices that manipulate signals based on operational instructions. Among other capabilities, the processor 1102 is configured to fetch and execute computer-readable instructions and data stored in the memory 1104.

The memory 1104 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The data 1106 serves, amongst other things, as a repository for storing data processed, received, and generated by the processor 1102.

Based on advanced technology for 6G applications in the context of Split Computing, the proposed techniques can be implemented in smart home or smart factory to increase the life-time of edge computing network.

Using the disclosed techniques, multiple computationally capable devices are used for edge devices (such as an Android device) to perform DNN tasks. Using the discloses techniques, battery consumption is spread across multiple Android devices, reducing overload on single device and successfully completing the given tasks from IoT devices (such as Raspberry Pi™)

The disclosed techniques avoid tasks from abruptly ending using load balancing technique based on energy profiling.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts.

The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method of task management in an internet of things (IoT)-edge network, the edge network including an IoT device and a plurality of edge devices, and the method comprising:
assigning at least one deep neural network (DNN) task from an IoT device to a first edge device;
determining whether the first edge device satisfies one of a first predetermined criteria and a second predetermined criteria during execution of the at least one DNN task;
triggering an alarm to the IoT device based on the determination;
identifying a second edge device subsequent to the triggering of the alarm;
transferring the at least one DNN task to the second edge device, based on determining that the first device satisfies the first predetermined criteria; and
determining whether to transfer the at least one DNN task to the second edge device or to execute the at least one DNN task on the first edge device, based on determining that the first device satisfies the second predetermined criteria.

2. The method of claim 1, wherein the assigning comprises: splitting a plurality of DNN tasks into one or more groups of DNN tasks; and
assigning at least one of the one or more groups of DNN tasks to the first edge device.

3. The method of claim 1, wherein prior to assigning the at least one DNN task, the method comprises:
identifying a nearest edge device as the first edge device to assign the at least one DNN task, using a path loss method.

4. The method of claim 1, wherein the first predetermined criteria is based on a battery level of the first edge device, and wherein determining whether the first edge device satisfies the first criteria comprises:
receiving the battery level of the first edge device at predetermined time intervals; and
determining that the battery level of the first edge device is below a predefined threshold.

5. The method of claim 1, wherein the second predetermined criteria is based on a priority task, and wherein determining whether the first edge device satisfies the second predetermined criteria comprises:
receiving an indication that the priority task is assigned to the first edge device.

6. The method of claim 5, wherein determining whether to transfer the at least one DNN task to the second edge device or to execute the at least one DNN task on the first edge device comprises one of:
transferring the at least one DNN task to the second edge device for execution while executing the priority task at the first edge device; and
executing the at least one DNN task at the first edge device while transferring the priority task to the second edge device.

7. The method of claim 1, wherein identifying the second edge device comprises:
identifying a second nearest edge device as the second edge device, using a path loss method.

8. The method of claim 1, wherein the IoT device has a first computing capability and each of the plurality of edge devices have a respective second computing capability, the respective second computing capability being higher than the first computing capability.

9. A system of task management in an internet of things (IoT)-edge network, the IoT-edge network including an IoT device and a plurality of edge devices, and the system comprising:
a memory; and
a processor coupled to the memory and configured to:
assign at least one deep neural network (DNN) task from an IoT device to a first edge device;
determine whether the first edge device satisfies one of a first predetermined criteria and a second predetermined criteria during execution of the at least one DNN task;
trigger an alarm to the IoT device based on the determination;
identify a second edge device subsequent to the alarm;
transfer the at least one DNN task to the second edge device, based on determining that the first device satisfies the first predetermined criteria; and
determine whether to transfer the at least one DNN task to the second edge device or to execute the at least one DNN task on the first edge device, based on determining that the first device satisfies the second predetermined criteria.

10. The system of claim 9, wherein the processor is configured to assign the at least one DNN task by:
splitting a plurality of DNN tasks into one or more groups of DNN tasks; and
assigning at least one of the one or more groups of DNN tasks to the first edge device.

11. The system of claim 9, wherein prior to assigning the at least one DNN task, the processor is configured to:
identify a nearest edge device as the first edge device to assign the at least one DNN task, using a path loss method.

12. The system of claim 9, wherein the first predetermined criteria is based on a battery level of the first edge device, and wherein the processor determining whether the first edge device satisfies the first predetermined criteria us configured to:
receive the battery level of the first edge device at predetermined time intervals; and
determine that the battery level of the first edge device is below a predefined threshold.

13. The system of claim 9, wherein the second predetermined criteria is based on a priority task, and wherein the processor determining whether the first edge device satisfies one of the second predetermined criteria is configured to:
receive an indication that the priority task is assigned to the first edge device.

14. The system of claim 13, wherein to determine whether to transfer the at least one DNN task to the second edge device or to execute the at least one DNN task on the first edge device, the processor is configured to perform at least one of:
transfer the at least one DNN task to the second edge device for execution while executing the priority task at the first edge device; and
execute the at least one DNN task at the first edge device while transferring the priority task to the second edge device.

15. The system of claim 9, wherein the processor identifies the second edge device by identifying a second nearest edge device as the second edge device, using a path loss method.

16. The system of claim 9, wherein the IoT device has a first computing capability and each of the plurality of edge devices have a respective second computing capability, the respective second computing capability being higher than the first computing capability.

17. A method of distributed task management in an Internet of Things-Edge (IoT-edge) network, the IoT-edge network including an IoT device and a plurality of edge devices, the method comprising:
assigning at least one deep neural network (DNN) task from the IoT device to a first edge device from the plurality of edge devices;
determining whether the first edge device satisfies at least one of a first predetermined criteria and a second predetermined criteria;
based on the first edge device satisfying the first predetermined condition or the second predetermined condition, triggering an alarm at the IoT device;
subsequent to the triggering of the alarm, determining a second edge device from the plurality of edge devices;
based on the first predetermined condition being satisfied, transferring the at least one DNN task to the second edge device; and
based on the second predetermined condition being satisfied, determining whether to transfer the at least one DNN task to the second edge device or execute the at least one DNN task at the first device.

18. The method according to claim 1, wherein subsequent to the second predetermined condition being satisfied, the method further comprises one of:
transferring the at least one DNN task to the second edge device for execution while executing the priority task at the first edge device; and
transferring the priority task to the second edge device for execution and executing the at least one DNN task at the first edge device.

19. The method according to claim 18, wherein the at least one DNN task is transferred to the second edge device for execution without being restarted.

20. The method according to claim 17, wherein the second predetermined criteria is based on another task being assigned to the first edge device, and wherein the determining whether to transfer the at least one DNN task to the second edge device or execute the at least one DNN task at the first device is based on a priority of the another task assigned to the first edge device.
